(19) United States
(12) Patent Application Publication
(10) Pub. No.: US 2026/0297255 A1
(43) Pub. Date: Oct. 1, 2026

(54) HIGH MELT TEMPERATURE SOLUBLE SEMI-CRYSTALLINE POLYAMIDES

(71) Applicant: Syensqo Specialty Polymers USA, LLC, Alpharetta, GA (US)

(72) Inventors: Tanner Gerschick, Roswell, GA (US); Nancy J. Singletary, Alpharetta, GA (US)

(73) Assignee: Syensqo Specialty Polymers USA, LLC, Alpharetta, GA (US)

(21) Appl. No.: 19/703,924

(22) Filed: Jun. 10, 2026

Related U.S. Application Data
(63) Continuation of application No. 18/003,878, filed on Jun. 16, 2021, now abandoned.
(60) Provisional application No. 63/045,821, filed on Jun. 29, 2020.

(51) Int. Cl. C08G 69/26; B29C 64/40; B29K 77/00; B33Y 10/00; B33Y 70/00

(52) U.S. Cl. CPC C08G 69/26; B29C 64/40; B33Y 70/00; B29K 2077/00; B33Y 10/00

(57) ABSTRACT

The present invention relates to (co)polyamides comprising at least 85 mole % (mol. %) of recurring units (R_{PA}) of formula (I):

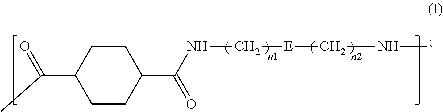

the present invention also relates to polymer compositions comprising such (co)polyamides, as well as articles comprising the same and methods of using said articles in high temperature applications requiring sufficient swelling or deformation upon exposure to moisture, such as for example oil and gas extraction processes (e.g. fracturing balls), or as support materials used to print three-dimensional (3D) parts.

### TECHNICAL FIELD

The present invention relates to (co)polyamides comprising at least 85 mole % (mol. %) of recurring units (R_{PA}) of formula (I):

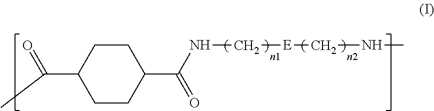

with respect to the total moles of recurring units of the said (co)polyamide [polyamide (A)], wherein:
each of E, equal or different at each occurrence, is a group of any of formula (I_{N}¹) or (I_{N}²):

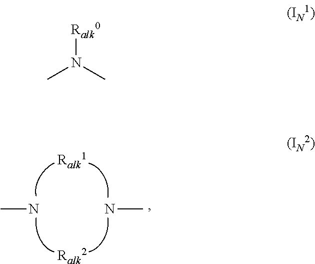

as further detailed below. The present invention also relates to polymer compositions comprising such polyamide (A), as well as articles comprising the same and methods of using said articles in high temperature applications requiring hydrolytic behaviour upon exposure to aqueous media, such as for example oil and gas extraction processes (e.g. for dissolvable O&G tools, such as frac-plugs, frac-balls and the like), or as support materials used to print three-dimensional (3D) parts.

### BACKGROUND ART

(Co)polyamides having a high melting temperature, for example above 300° C., are known and described in the literature. Polyamides of this type are notably known from Solvay Specialty Polymers USA, under the trade name Amodel® PPA. These polyamides also present a low water absorption rate which is, in many applications, a useful advantage, notably because of the resulting strength and stiffness stability, even with high levels of humidity.

In some applications however, such as the ones depicted below, there is need for (co)polyamides presenting high melting temperatures, but at the same time possessing ability to dissolve when immerged into an aqueous medium. For instance, in fabricating 3D parts by depositing layers of a part material, supporting layers or structures are typically built underneath overhanging portions or in cavities of 3D parts under construction, which are not supported by the part material itself. A support structure may be built utilizing the same deposition techniques by which the part material is deposited. The host computer generates additional geometry acting as a support structure for the overhanging or free-space segments of the 3D part being formed, and in some cases, for the sidewalls of the 3D part being formed. The support material adheres to the part material during fabrication, and is removable from the completed 3D part when the printing process is complete. Generally, soluble/leachable materials are preferred as support materials, enabling hence dissolving the support parts from the final 3D part, once the same is built, so that a soak and rinse post-processing is effective in recovering the part. Use of a soluble support as opposed to a support that can only be removed mechanically allows increased part design freedom and retention of part surface aesthetics. Soluble/water swellable and/or printable materials have been already described in the art, including polyamide support material. For instance, WO 2017/167691 (to Solvay Specialty Polymers USA, LLC) is directed to a method for manufacturing a 3D-object using as support material a semi-crystalline polyamide, possessing a water uptake sufficient to provide for significant swelling and deformation, so as to ensure detachment from the target 3D part. Among suitable polyamides, is mention made of polyamides which can be obtained from polycondensation of certain diacids with certain diamines, among which is mention made of N-methyl-bis-hexamethylene-triamine. Similarly, US 2019/0160732 teaches a soluble polyamide useful as support material in 3D printing techniques, containing units from a hydrophilic monomer, units from a hydrophobic dicarboxylic acid monomer and units from a hydrophobic amine monomer, whereas the hydrophilic monomer unit may comprise a primary amino group, a secondary amino group, a tertiary amino group, a quaternary ammonium salt, an oxyethylene group, a hydroxyl group, a carboxyl group, a carboxy salt group, a phosphoric acid group, a phosphate group, a sulphonic acid group, or a sulfonate group. Further, WO 2017/167692 (to Solvay Specialty Polymers USA, LLC) teaches (co)polyamides comprising more than 60% moles of recurring units derived from condensation of 1,4-cyclohexanedicarboxylic acid and a diamine of formula H₂N—(CH₂)₂—O—(CH₂)₂—O—(CH₂)₂—NH₂, which possess melting points exceeding 260° C. and are endowed with sufficient solubility into water, acidic water or basic water, at temperatures exceeding 50° C., which is described as suitable as support material to print 3D parts. These (co)polyamides may additionally comprise other units such as units derived from an aromatic diacid and/or units derived from an aliphatic diamine; among these latter, mention is notably made of N,N-bis(3-aminopropyl)methylamine.

Nevertheless, choice of water-soluble polymers remains relatively limited and water-soluble polymer materials taught may be inadequate for supporting printing of certain polymers that require high processing temperatures, and in some cases soaking/rinsing detaching technique remains nevertheless quite burdensome, at least in that it requires high temperature dissolution, extensive post-treatment of significant amounts of waste waters (due to low solubility), for disposal and/or recovering of water-soluble support polymer.

As already explained above, in fabricating 3D parts in association with high-temperature part materials, such as polysulfones, polyethersulfones, polyphenylsulfones, polyaryletherketones, polyetherimides, polyamideimides, polyphthalamides, polyphenylene sulfide and the like, support materials are required to provide vertical and/or lateral support in the higher operating conditions required for the high-temperature part materials, and shall not soften too much under the higher operating conditions: deformation would otherwise render them ineffective as support structure materials.

The merit of the applicant has been to surprisingly identify structural requirements for (co)polyamides showing such advantageous properties. More precisely, the applicant has now found that such (co)polyamides comprising at least 85% moles of recurring units of formula (I) are such to simultaneously deliver high melt temperature behaviour, so as to serve efficiently as solid-state support materials in printing chambers operating at temperatures exceeding 200° C., while possessing rapid and high solubility in water borne media, so as to enable easy dissolution and recovery.

Several prior art documents relate to polyamides obtained from the condensation of amines possessing tertiary amine groups.

GB1281547 discloses fibre-forming compositions including polyesters and polyamides comprising basic nitrogen-containing groups, such as polyamides derived from polycondensation of diamines of any of formulae:

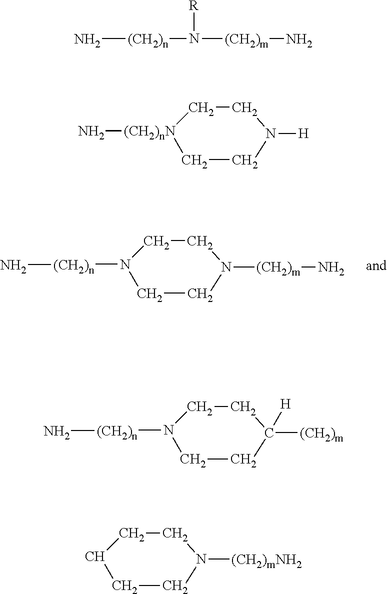

with dicarboxylic acids of formula HOOC—Y—COOH, with Y being —(CH₂)ₚ— (p being at least 4), or —(CH₂)ₐ—Z—(CH₂)_{b}—, with Z being meta- or para-phenylene, which are used for formulating polyester dyable fibre-forming formulations.

US2016/108174 is directed polyamides obtained through polymerisation of at least one or several alkyl-BHT diamine chosen from methyl-bis hexamethylene triamine, ethyl-bis hexamethylene triamine, n-propyl-bis hexamethylene triamine and/or i-propyl-bis hexamethylene triamine, and one or several polycarboxylic acid. Among polycarboxylic acids, is notably mention made of cycloaliphatic dicarboxylic acids comprising at least one carbocyclic ring having from 4 to 8 carbon atoms in the ring, like e.g. cyclohexane dicarboxylic acids, in particular such as 1,2-cyclohexane carboxylic acid, 1,3-cyclohexane dicarboxylic acid and 1,4-cyclohexane dicarboxylic acid, and 2,5-tetrahydrofurandicarboxylic acid.

US 2018/0236804 describes water-soluble or water-dispersible polyamides, suitable for use in a photosensitive composition for the manufacture of a relief printing original plate, including from 30 to 90% moles of units having an alicyclic moiety either derived from an alicyclic-containing diamine or from an alicyclic-containing diacid, whereas the alicyclic-containing diamine may be 1,4-cyclohexane diamine, 1,3-cyclohexanediamine, 1,3-bis(aminomethyl)cyclohexane, 1,4-bis(aminomethyl)cyclohexane, norbornyldiamine, 1,4-bis(3-aminopropyl) piperazine and N-(2-aminoethyl) piperazine, and whereas the alicyclic-containing diacid maybe isophoronedicarboxylic acid, 1,4-cyclohexanedicarboxylic acid, 2,3-norbornane-dicarboxylic acid, and 1,3-cyclohexanedicarboxylic acid. Several exemplary embodiments are representative of polyamides comprising units derived from 1,4-cyclohexanedicarboxylic acid and a diamine such as 1,4-bis(3-aminopropyl) piperazine, or methylimino-bis-propylamide, in combination with significant amounts of other units, such as units derived from &-caprolactam or ω-laurolactam, or units derived from adipic acid and another diamine, leading to amorphous polyamides, possessing the target transparency for being used in the photoengraving process.

Notably, Ex. 8 of US 2018/0236804 provides for an amorphous copolyamide obtained by polycondensing ε-caprolactam (15 mol. %), 1,4-cyclohexanedicarboxylic acid (1,4-CHDA) (42.1 mol. %) and 1,4-bis(aminopropyl) piperazine (BAPP) (42.9 mol. %), hence leading to a copolyamide having about 25 mol. % or recurring units of formula —C(O)—(CH₂)₅—NH— and about 75 mol. % of units of formula:

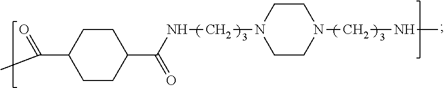

similarly, Ex. 11 provides for an amorphous copolyamide obtained by polycondensing s-caprolactam (15 mol. %), 1,4-cyclohexanedicarboxylic acid (1,4-CHDA) (42.1 mol. %) and methyl-bis hexamethylene triamine (MeBHT) (42.9 mol. %), hence leading to a copolyamide having about 25 mol. % or recurring units of formula-C(O)—(CH₂)₅—NH— and about 75 mol. % of units of formula:

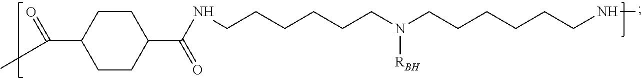

finally, Ex. 17 provides for an amorphous copolyamide obtained by polycondensing adipic acid (7.5 mol. %), 1,4-cyclohexanedicarboxylic acid (1,4-CHDA) (42.1 mol. %), 1,4-bis(aminopropyl) piperazine (BAPP) (42.9 mol. %), and hexamethylenediamine (7.5 mol. %), hence leading to a copolyamide having about 72 mol. % of recurring units of formula

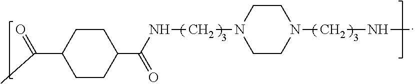

None of the above-listed documents describe (co)polyamides comprising at least 85 mol. % of recurring units of formula (I):

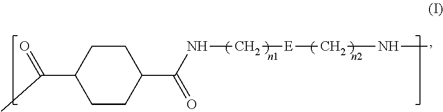

as described below, for example obtained from the condensation of certain diamines such as alkyliminobisalkylamines or bis(aminoalkyl) piperazines, with a 1,4-cyclohexanedicarboxylic acid (1,4-CHDA), with a limited amount of additional units tolerated in the polyamide (A) chain. The applicant has surprisingly found that polyamides (A) according to the invention not only present high melting temperatures (i.e. above 260° C.), but also possess significant solubility (higher than 30% wt/wt) in mild acidic water compositions (e.g. 5% wt. acetic acid in water) already at room temperature. Such technical features enable their uses not only in high temperature applications or in applications requiring sufficient swelling or deformation upon exposure to moisture, but also in applications requiring both a high temperature resistance and sufficient swelling or deformation upon exposure to moisture (e.g. oil and gas extractions, 3D printing).

### DISCLOSURE OF THE INVENTION

The present invention relates to (co)polyamides comprising at least 85 mole % (mol. %) of recurring units (R_{PA}) of formula (I):

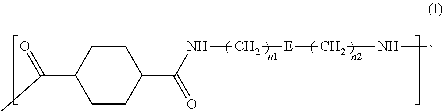

with respect to the total moles of recurring units of the said (co)polyamide [polyamide (A)], wherein:
each of E, equal or different at each occurrence, is a group of any of formula (I_{N}¹) or (I_{N}²):

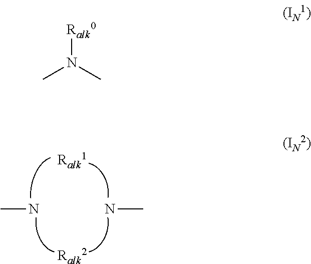

where Rₐₗₖ^{∘} is a mono-valent C₁-C₁₂ hydrocarbon group (preferably alkyl group), possibly comprising one or more than one heteroatom (e.g. O, N or S); each of Rₐₗₖ¹ and Rₐₗₖ², equal to or different from each other, are a bond or a divalent C₁-C₁₂ hydrocarbon groups (preferably alkylene groups), possibly comprising one or more than one heteroatom (e.g. O, N or S), with the provision that Rₐₗₖ¹ and Rₐₗₖ² are not simultaneously a bond, together forming a heterocyclic mono- or poly-nuclear group with the nitrogen atoms to which they are connected; and
n1 and n2, equal to or different from each other and at each occurrence, are integers, in particular from 1 to 12.

The Applicant has found that the selection of the specific combination of the alicyclic moiety

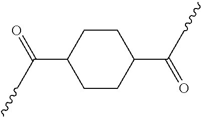

of the diacid-part and of the tertiary amine-containing moiety connected through non-sterically hindered —CH₂— bridges of the amine-part, coupled with the absence of limited presence (<15 mol. %) of different units is such to provide for a polyamide (A) having ability to crystallize in a regular lattice enabling achieving high melt temperatures, while the presence of tertiary amine groups is such to provide for easily accessible ionisable sites, with significantly contribute to deliver solubility is slightly acidic aqueous media.

The expression “recurring units” when associated to the inventive (co)polyamide is intended to designate units derived from polycondensation of a diamine and a diacid of formula (AABB) below, or units derived from polycondensation of an aminoacid or lactam, of formula (AB) below:

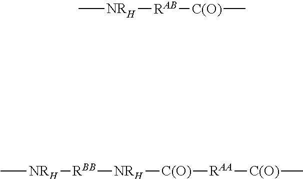

wherein R_{H} is hydrogen or a hydrocarbon group; and R^{AB}, R^{BB}, R^{AA}, equal to or different from each other, are divalent hydrocarbon groups, possibly including one or more than one heteroatom.

Recurring units (R_{PA}) of formula (I) are exemplary units of formula (AABB).

The expressions “(co)polyamides” or “polyamides” are hereby used for designating:
homopolyamides containing substantially 100 mol. % of recurring units (R_{PA}) of formula (I) and
copolyamides comprising at least about 85 mol. % of recurring units (R_{PA}) of formula (I), preferably at least about 90 mol. %, more preferably at least about 95 mol. %, for example at least about 96 mol. %, at least about 97 mol. %, at least about 98 mol. %, at least about 99 mol. %,
   with respect to the total moles of recurring units of the said (co)polyamide [polyamide (A)].

Recurring units (R_{PA}) of formula (I) above generally result from the polycondensation of a mixture of a dicarboxylic component consisting of one or more than one 1,4-cyclohexanedicarboxylic acid [acid (CHDA)] (or derivative thereof) and a diamine component consisting of one or more than one diamine (or derivatives thereof) of any of formulae:

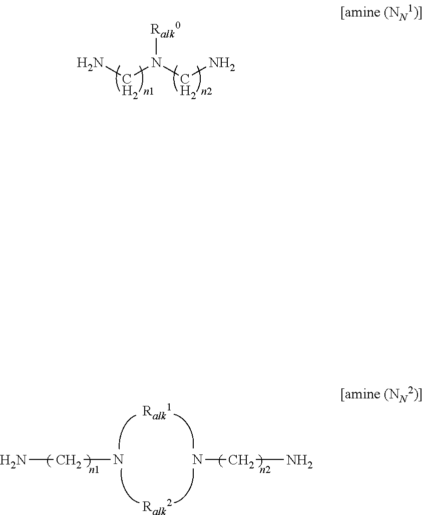

where Rₐₗₖ^{∘} is a mono-valent C₁-C₁₂ hydrocarbon group (preferably alkyl group), possibly comprising one or more than one heteroatom (e.g. O, N or S); each of Rₐₗₖ¹ and Rₐₗₖ², equal to or different from each other, is a bond or a divalent C₁-C₁₂ hydrocarbon group (preferably alkylene groups), possibly comprising one or more than one heteroatom (e.g. O, N or S), with the provision that Rₐₗₖ¹ and Rₐₗₖ² are not simultaneously a bond, and wherein Rₐₗₖ¹ and Rₐₗₖ² are together forming a heterocyclic mono- or poly-nuclear group with the nitrogen atoms to which they are connected; and
n1 and n2, equal to or different from each other and at each occurrence, are integers, in particular from 1 to 12.

Acid (CHDA) derivatives include notably salts, anhydride, esters and acid halides, able to form amide groups; similarly, amine (N_{N}¹) and (N_{N}²) derivatives include notably salts thereof, equally able to form amide groups.

The expression “one or more than one 1,4-cyclohexanedicarboxylic acid” in liaison with acid (CHDA) is meant to encompass the use of diastereoisometrically pure cis or trans diastereoisomers, and mixtures thereof, in whichever proportions. Generally, mixtures of cis and trans diastereroisomers of acid (CHDA) are used.

Preferably, recurring units (R_{PA}) of formula (I) are selected from the group consisting of:
units (R_{PA}¹) of formula:

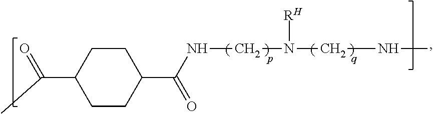

wherein p and q, equal to or different from each other, are independently an integer of 3 to 9, preferably of 4 to 6, most preferably each of p and q being 6; R^{H} is a mono-valent C₁-C₆ alkyl group, in particular selected from the group consisting of methyl, ethyl, propyl (including iso-propyl, n-propyl); and
units (R_{PA}²) of formula:

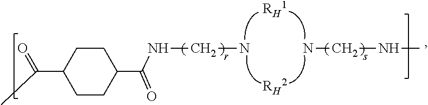

wherein r and s, equal to or different from each other, are independently an integer of 1 to 3; each of R_{H}¹ and R_{H}², equal to or different from each other are a bond of a divalent C₁-C₁₂ alkylene group, possibly comprising a catenary nitrogen atom, and wherein R_{H}¹ and R_{H}² are together forming an azacycloalkane with the nitrogen atoms to which they are connected.

Particular embodiments of units (R_{PA}¹) are notably those wherein each of p and q are equal to 6, that is to say those of formula:

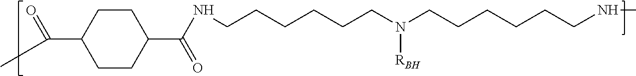

whereas R_{BH} is a C₁-C₃ alkyl group, in particular selected from the group consisting of methyl, ethyl, and propyl (iso-propyl, n-propyl) group. These preferred units (R_{PA}¹) generally result from the polycondensation of a mixture of a dicarboxylic component consisting of one or more than one 1,4-cyclohexanedicarboxylic acid [acid (CHDA)] (or derivative thereof) and a diamine component consisting of methyl-bis hexamethylene triamine, ethyl-bis hexamethylene triamine, n-propyl-bis hexamethylene triamine, i-propyl-bis hexamethylene triamine or a mixture thereof, most preferably consisting of methyl-bis hexamethylene triamine (i.e. of formula as above depicted, with R_{BH} being methyl).

Particular embodiments of units (R_{PA}²) are notably:
those wherein the azacycloalkane is an imidazoline ring, such as units of formula:

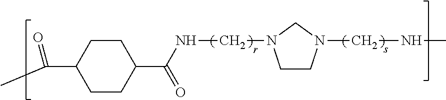

wherein r and s, equal to or different from each other, are independently an integer of 1 to 3;
those wherein the azacycloalkane is a pyrazolidine ring, such as units of formula:

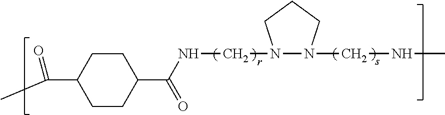

wherein r and s, equal to or different from each other, are independently an integer of 1 to 3;
those wherein the azacycloalkane is a 1,4-diazacyclohexane ring, aka a piperazine ring, such as units of formula:

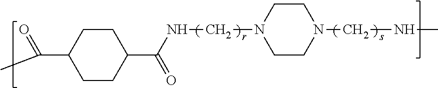

wherein r and s, equal to or different from each other, are independently an integer of 1 to 3;
those wherein the azacycloalkane is a 1,3-diazacyclohexane ring, such as units of formula:

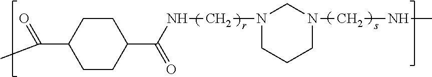

wherein r and s, equal to or different from each other, are independently an integer of 1 to 3;
those wherein the azacycloalkane is a 1,4-diazacycloheptane, such as units of formula:

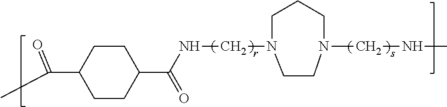

wherein r and s, equal to or different from each other, are independently an integer of 1 to 3;
those wherein the azacycloalkane is a 1,3,5,7-tetraazacyclooctane ring, such as units of formulae:

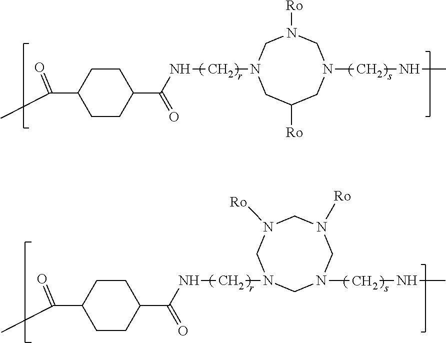

wherein

Ro is H or a C₁-C₃ alkyl group, and r and s, equal to or different from each other, are independently an integer of 1 to 3;
those wherein the azacycloalkane is a 1,4,8,11-tetraazacyclotetradecane ring, such as units of formula:

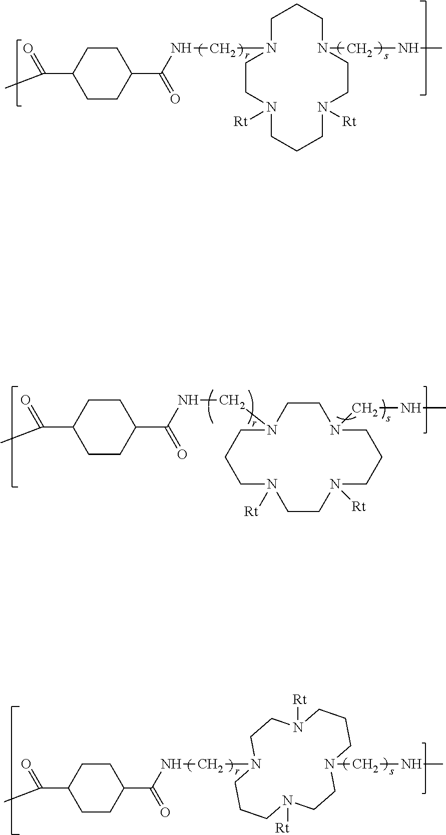

wherein Rt is H or a C₁-C₃ alkyl group, and r and s, equal to or different from each other, are independently an integer of 1 to 3.

Most preferred embodiments of units (R_{PA}²) are those units whereas the azacycloalkane is a 1,4-diazacyclohexane ring, i.e. units of formula:

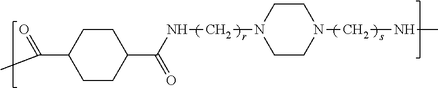

wherein r and s, equal to or different from each other, are independently an integer of 1 to 3.

These preferred units (R_{PA}²) generally result from the polycondensation of a mixture of a dicarboxylic component consisting of one or more than one 1,4-cyclohexanedicarboxylic acid [acid (CHDA)] (or derivative thereof) and a diamine component consisting of one or more than one 1,4-bis(aminoalkyl) piperazine, whereas the aminoalkyl group is a group selected from an aminomethyl, an amino ethyl, and an aminopropyl group.

A particularly preferred embodiment of units (R_{PA}²) is the unit of formula:

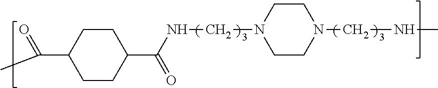

which generally results from the polycondensation of a mixture of a dicarboxylic component consisting of one or more than one 1,4-cyclohexanedicarboxylic acid [acid (CHDA)] (or derivative thereof) and a diamine component consisting of 1,4-bis(3-aminopropyl) piperazine.

As said, polyamide (A) may comprise at most about 15 mol. %, preferably at most about 10 mol. %, more preferably at most about 5 mol. %, notably at most about 4 mol. %, at most about 3 mol. %, at most about 2 mol. % or at most about 1 mol. %, with respect to the total moles of recurring units of the polyamide (A), of recurring units different from those of formula (I) above, which comply with any of the formulae:

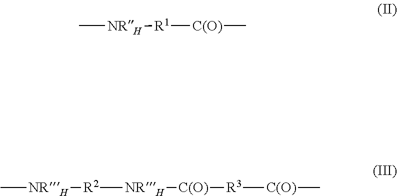

wherein R″_{H} and R′″_{H}, equal to or different from each other and at each occurrence, are H or a hydrocarbon group; and R¹, R², R³, equal to or different from each other, are divalent hydrocarbon groups, and may be aliphatic, alicyclic, cycloaliphatic, aromatic or combinations thereof, wherein R¹, R², R³ may contain one or more than one heteroatom selected from the group consisting of O, N, S, P.

Specifically, recurring units (II) and (III) different from units of formula (I) of the polyamide (A) may be the condensation product of at least one mixture selected from:
mixtures (M1) comprising at least a diacid [acid (DA)] (or derivative thereof) and at least a diamine [amine (NN)] (or derivatives thereof), wherein (i) acid (DA) is not an acid (CHDA) and/or (ii) amine (NN) is not an amine (N_{N}¹) nor an amine (N_{N}²);
mixtures (M2) comprising at least a lactam [lactam (L)];
mixtures (M3) comprising at least an aminocarboxylic acid [aminoacid (AN)]; and
combinations thereof.

Similarly as above, acid (DA) derivatives include notably salts, anhydride, esters and acid halides, able to form amide groups; similarly, amine (NN) derivatives include notably salts thereof, equally able to form amide groups.

Said acid (DA) can be an aromatic dicarboxylic acid comprising two reactive carboxylic acid groups [acid (AR)] or an aliphatic dicarboxylic acid comprising two reactive carboxylic acid groups [acid (AL)]. For the purpose of the present invention, a dicarboxylic acid is considered as “aromatic” when it comprises one or more than one aromatic group.

Non limitative examples of acids (AR) are notably phthalic acids, including isophthalic acid (IA), and terephthalic acid (TA), 2,5-pyridinedicarboxylic acid, 2,4-pyridinedicarboxylic acid, 3,5-pyridinedicarboxylic acid, 2,2-bis(4-carboxyphenyl) propane, bis(4-carboxyphenyl) methane, 2,2-bis(4-carboxyphenyl) hexafluoropropane, 2,2-bis(4-carboxyphenyl) ketone, 4,4′-bis(4-carboxyphenyl) sulfone, 2,2-bis(3-carboxyphenyl) propane, bis(3-carboxyphenyl) methane, 2,2-bis(3-carboxyphenyl) hexafluoropropane, 2,2-bis(3-carboxyphenyl) ketone, bis(3-carboxyphenoxy)benzene, naphthalene dicarboxylic acids, including 2,6-naphthalene dicarboxylic acid, 2,7-naphthalene dicarboxylic acid, 1,4-naphthalene dicarboxylic acid, 2,3-naphthalene dicarboxylic acid, 1,8-naphthalene dicarboxylic acid and biphenyl-4,4′-dicarboxylic acid.

Among acids (AL), mention can be notably made of oxalic acid (HOOC—COOH), malonic acid (HOOC—CH₂—COOH)), succinic acid [HOOC—(CH₂)₂—COOH)], glutaric acid [HOOC—(CH₂)₃—COOH)], 2,2-dimethyl-glutaric acid [HOOC—C(CH₃)₂—(CH₂)₂—COOH)], adipic acid [HOOC—(CH₂)₄—COOH)], 2,4,4-trimethyl-adipic acid [HOOC—CH(CH₃)—CH₂—C(CH₃)₂—CH₂—COOH)], pimelic acid [HOOC—(CH₂)₅—COOH)], suberic acid [HOOC—(CH₂)₆—COOH)], azelaic acid [HOOC—(CH₂)₇—COOH)], sebacic acid [HOOC—(CH₂)₈—COOH)], undecanedioic acid [HOOC—(CH₂)₉—COOH)], dodecanedioic acid [HOOC—(CH₂)₁₀—COOH)], tridecanedioic acid [HOOC—(CH₂)₁₁—COOH], tetradecanedioic acid [HOOC—(CH₂)₁₂—COOH)], octadecanedioic acid [HOOC—(CH₂)₁₆—COOH)].

Yet, acids (AL) which can be used include cycloaliphatic-group containing acids, including notably 1,3-cyclohexane dicarboxylic acids, as cis or trans diastereoisomers, possibly in admixture.

According to certain embodiments, acids (DA) comprising ionisable groups can be used [acids (IDA)] as polycondensation monomers of polyamide (A); among these ionisable groups, mention can be notably made of phenolic hydroxylic groups, sulfonic groups (generally aromatic sulfonic groups), phosphonic groups, onium groups (including phosphonium and ammonium groups) and the like. Non-limiting examples of acids (IDA) of this type which can be used within the frame of the present invention are notably 4-hydroxyisophthalic acid, 5-hydroxyisophthalic acid, 2-hydroxyterephthalic acid, 2,5-dihydroxyterephthalic acid, 4,6-dihydroxyisophthalic acid, 5-sulfoisophthalic acid (and salts thereof, e.g. Li, K, Na, Ag salts), and 2-sulfoterephthalic acid (and salts thereof, e.g. Li, K, Na, Ag salts).

Acids (IDA) including ionisable groups may be used in combination with acids (AR) and/or (AL), as above detailed.

The amine (NN) is generally selected from the group consisting of aliphatic diamines (NNₐₗ), aromatic diamines (NNₐᵣ) and mixtures thereof.

Said diamines (NNₐₗ) are typically aliphatic diamines having 2 to 18 carbon atoms.

Said diamine (NNₐₗ) is advantageously selected from the group consisting of 1,2-diaminoethane, 1,2-diaminopropane, propylene-1,3-diamine, 1,3-diaminobutane, 1,4-diaminobutane, 1,5-diaminopentane, 1,5-diamino-2-methylpentane, 1,4-diamino-1,1-dimethylbutane, 1,4-diamino-1-ethylbutane, 1,4-diamino-1,2-dimethylbutane, 1,4-diamino-1,3-dimethylbutane, 1,4-diamino-1,4-dimethylbutane, 1,4-diamino-2,3-dimethylbutane, 1,2-diamino-1-butylethane, 1,6-diaminohexane, 1,7-diaminoheptane, 1,8-diamino-octane, 1,6-diamino-2,5-dimethylhexane, 1,6-diamino-2,4-dimethylhexane, 1,6-diamino-3,3-dimethylhexane, 1,6-diamino-2,2-dimethylhexane, 1,9-diaminononane, 1,6-diamino-2,2,4-trimethylhexane, 1,6-diamino-2,4,4-trimethylhexane, 1,7-diamino-2,3-dimethylheptane, 1,7-diamino-2,4-dimethylheptane, 1,7-diamino-2,5-dimethylheptane, 1,7-diamino-2,2-dimethylheptane, 1,10-diaminodecane, 1,8-diamino-1,3-dimethyloctane, 1,8-diamino-1,4-dimethyloctane, 1.8-diamino-2,4-dimethyloctane, 1,8-diamino-3,4-dimethyloctane, 1.8-diamino-4,5-dimethyloctane, 1.8-diamino-2,2-dimethyloctane, 1.8-diamino-3,3-dimethyloctane, 1,8-diamino-4,4-dimethyloctane, 1,6-diamino-2,4-diethylhexane, 1,9-diamino-5-methylnonane, 1,11-diaminoundecane and 1,12-diaminododecane, 1,13-diaminotridecane, 2,5-bis(aminomethyl)tetrahydrofurane, N-methyl-bis-hexamethylene-triamine.

The diamine (NNₐₗ) preferably comprises at least one diamine selected from the group consisting of 1,6-diaminohexane, 1,8-diamino-octane, 1,10-diaminodecane, 1,12-diaminododecane and mixtures thereof. More preferably, the aliphatic alkylene diamine comprises at least one diamine selected from the group consisting of 1,6-diaminohexane, 1,10-diaminodecane and mixtures thereof. Even more preferably, the aliphatic alkylene diamine is 1,6-diaminohexane.

The diamine (NNₐᵣ) is preferably selected from the group consisting of meta-phenylene diamine, meta xylylene diamine and para xylylene diamine, 3,4′-diaminodiphenyl ether (3,4′-ODA), 4,4′-diaminodiphenyl ether (4,4′-ODA) p-xylylene diamine (PXDA) and m-xylylenediamine (MXDA).

According to other embodiment's, at least one of the amine (NN) is a cycloaliphatic diamine, i.e. a diamine comprising a cycloaliphatic group [amine (cNN)]; the amine (cNN) is generally selected from the group consisting of isophoronediamine, bis(3,5-dialkyl-4-aminocyclohexyl) methane, bis(3,5-dialkyl-4-aminocyclohexyl) ethane, bis(3,5-dialkyl-4-aminocyclohexyl) propane, bis(3,5-dialkyl-4-aminocyclohexyl) butane, bis(3-methyl-4-aminocyclohexyl) methane, p-bis(aminocyclohexyl) methane, isopropylidenedi (cyclohexylamine), 4,4′-diamino-3,3′-dimethyldicyclohexylmethane, 1,4-bis(aminomethyl)cyclohexane, 1,3-bis(aminomethyl)cyclohexane, and 1,4-diaminocyclohexane.

According to certain other embodiments, at least one of the amine (NN) comprises ethereal bonds can be used [amine (NNE)] as polycondensation monomers of polyamide (A); exemplary embodiments of amine (NNE), otherwise referred to as polyetherdiamines are notably diamines comprising moieties of formula: —(OCH₂—CHR^{J})ₙ—, with RJ being H or a C₁-C₃ alkyl group, preferably-CH₃, and n being an integer of 1 to 15 and diamines comprising moieties of formula: —O—C(R′^{J})(R″^{J})—O—, with R′^{J} and R″^{J}, equal to or different from each other and at each occurrence, being H or a C₁-C₃ alkyl group, preferably —CH₃.

Exemplary embodiments thereof are amines (NNE) of any of formulae:

1)

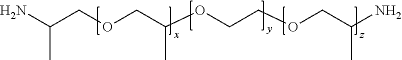

with x, and z being zero or integers, with y being an integer, with the provision that x+y+z is an integer of 1 to 15;
2)

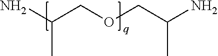

with q being an integer of 1 to 15;
3)

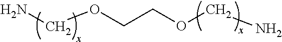

with each of x, equal to or different from each other, being an integer of 1 to 6;
4)

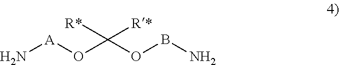

wherein R* and R′*, equal to or different from each other, are independently hydrogen, a C₁-C₃ alkyl group; A is alkyl, alkenyl, alkenene, alkylene-hetero-alkylene, alkylene-heterocyclo-alkylene, alkylene, alkylene-oxy-alkylene, 1,4-alkyl substituted piperazine, carbonyl, thiocarbonyl; B is alkyl, alkenyl, alkenene, alkylene-hetero-alkylene, alkylene-heterocyclo-alkylene, alkylene, alkylene-oxy-alkylene, 1,4-alkyl substituted piperazine, carbonyl, thiocarbonyl; R2 is hydrogen, alkyl, aminoalkyl, alkyl-amino-alkyl, cycloalkyl, heterocycloalkyl, alkenyl, aryl, or heteroaryl; amines complying with this structural formula are notably disclosed in WO 2013/007128 (ADVANCED MATERIALS WUXI CO. LTD.) Jan. 17, 2013

Lactam (L) suitable for use for the manufacture of polyamide (A) can be any of β-lactam or ε-caprolactam, dodecanolactam.

Aminoacid (AN) suitable for use for the manufacture of polyamide (A) can be selected from the group consisting of 6-amino-haxanoic acid, 9-aminononanoic acid, 10-aminodecanoic acid, 11-aminoundecanoic acid, 12-aminododecanoic acid, 13-aminotridecanoic acid.

It is still within the scope of the invention the addition to any of mixtures (M1), (M2), (M3), and their combinations, of one or more than one polyfunctional acid/amine monomers comprising more than two carboxylic acid and amine groups, e.g. polycarboxylic acid having three or more carboxylic acid groups, polyamines having three or more amine groups, e.g. polyamides comprising both primary and secondary amine groups, polyfunctional diacid including two carboxylic groups and one or more amine groups, polyfunctional diamine including two amine groups and one or more carboxylic acid groups. Incorporation of said polyfunctional acid/amine monomers generally lead to branched structures, star-like or tree-like, such as those notably described in WO 97/24388 (NYLTECH ITALIA) Oct. 7, 1997 and in WO 99/64496 (NYLTECH ITALIA) Dec. 16, 1999.

It is nevertheless preferred for the polyamide (A) to be selected among homopolyamides or quasi-homopolyamide essentially consisting of recurring units (R_{PA}) of formula (I). The expression ‘essentially consisting of recurring units”, when used in liaison with polyamide (A) is meant to indicate that end-groups, impurities, defects and other spurious units in very limited amount (less than 1 mol. %, preferably less than 0.5 mol. %, with respect to total moles of recurring units) may be present in the polymer (A), in addition to the listed recurring units, without this affecting substantially the properties of the said polyamide (A).

The polyamide (A) of the present invention can be prepared by any conventional method, for example, by thermal polycondensation from a monomer mixture comprising at least one acid (CHDA) and at least one of amine (N_{N}¹) and an amine (N_{N}²), and possibly additionally comprising at least one of mixtures (M1), (M2) and (M3), as described above.

In monomers mixtures used for manufacturing polyamide (A) via condensation process, the molar ratio n_{diacid}/n_{diamine} ranges from 0.8 to 1.2. In the context of the present invention, the term “n_{diacid}” means total number of moles of diacid species e.g. involved in the condensation process. Similarly, the term “n_{diamine}” means total number of moles of diamine species e.g. involved in the condensation process. As an example, if the condensation process involves one additional diacid species, in addition to the acid (CHDA), then n_{diacid}=n_{1CHDA}+n_{DA}. According to the present invention, the molar ratio n_{diacid}/n_{diamine} may range between 0.8 and 1.2, between 0.9 and 1.1, between 0.95 and 1.05 or between 0.98 and 1.02.

The polyamide (A) of the present invention may have a number average molecular weight MN ranging from 1 000 g/mol to 50 000 g/mol, for example from 2 000 g/mol to 40 000 g/mol or from 4 000 to 35 000 g/mol. The number average molecular weight can be determined by gel permeation chromatography (GPC) following ASTM D5296 instructions, against substantially monodisperse polystyrene standards.

The polyamide (A) of the present invention is semi-crystalline. By “semi-crystalline” is meant a polymer having an amorphous phase and a crystalline phase, leading to a detectable melting point, as determined by Differential Scanning calorimetry according to ASTM D3418.

More specifically, the polyamide (A) has a crystallinity such that its heat of fusion is of at least 5 J/g, preferably at least 10 J/g, more preferably at least 15 J/g, when determined by Differential Scanning calorimetry according to ASTM D3418.

The polyamide (A) of the present invention has advantageously a melting point of at least about 250° C., as determined according to ASTM D3418. The polyamide (A) of the present invention may have for example a melting point of at least about 255° C., at least about 258° C. or at least about 260° C.

As explained, the semi-crystalline character of the polyamide (A), and most importantly the presence of a crystalline phase having a melt temperature exceeding 250° C., is material for maintaining structural integrity and mechanical properties in the solid phase, up to temperatures which are close to the said melting point, so rendering polyamide (A) suitable as support material for applications whereas long term exposure to temperatures beyond 200° C. is foreseen.

### Composition Comprising Polyamide (A)

The polyamide composition (C) comprising the polyamide (A) of the present invention, above described, is another object of the present invention.

The polyamide (A) may be present in the composition (C) in a total amount of greater than 30 wt. %, greater than 35 wt. % by weight, greater than 40 wt. % or greater than 45 wt. %, based on the total weight of the polymer composition (C). The (co)polyamides may be present in the composition (C) in a total amount of less than 95 wt. %, notably less than 90 wt. %, less than 80 wt. %, less than 70 wt. % or less than 60 wt. %, based on the total weight of the polymer composition (C).

The polyamide (A) may for example be present in the composition (C) in an amount ranging between 35 and 60 wt. %, for example between 40 and 55 wt. %, based on the total weight of the polyamide composition (C).

The composition (C) may also comprise one component selected from the group consisting of reinforcing agents, tougheners, plasticizers, colorants, pigments, antistatic agents, dyes, lubricants, thermal stabilizers, light stabilizers, flame retardants, nucleating agents, crosslinking agents, and antioxidants.

A large selection of reinforcing agents, also called reinforcing fibers or fillers, may be added to the composition according to the present invention. They can be selected from fibrous and particulate reinforcing agents. A fibrous reinforcing filler is considered herein to be a material having length, width and thickness, wherein the average length is significantly larger than both the width and thickness. Generally, such a material has an aspect ratio, defined as the average ratio between the length and the largest of the width and thickness of at least 5, at least 10, at least 20 or at least 50.

The reinforcing filler may be selected from mineral fillers (such as talc, mica, kaolin, calcium carbonate, calcium silicate, magnesium carbonate), glass fibers, carbon fibers, synthetic polymeric fibers, aramid fibers, aluminum fibers, titanium fibers, magnesium fibers, boron carbide fibers, rock wool fibers, steel fibers and wollastonite.

Among fibrous fillers, glass fibers and carbon fibers are preferably used, with carbon fibers being mostly preferred; glass fibers include chopped strand A-, E-, C-, D-, S- and R-glass fibers, as described in chapter 5.2.3, p. 43-48 of Additives for Plastics Handbook, 2nd edition, John Murphy. As used herein, the term “carbon fiber” is intended to include graphitized, partially graphitized and ungraphitized carbon reinforcing fibers or a mixture thereof. Carbon fibers useful for the present invention can advantageously be obtained by heat treatment and pyrolysis of different polymer precursors such as, for example, rayon, polyacrylonitrile (PAN), aromatic polyamide or phenolic resin; carbon fibers useful for the present invention may also be obtained from pitchy materials. The term “graphite fiber” intends to denote carbon fibers obtained by high temperature pyrolysis (over 2000° C.) of carbon fibers, wherein the carbon atoms place in a way similar to the graphite structure. Carbon fibers useful for the present invention are preferably chosen from the group composed of PAN-based carbon fibers, pitch based carbon fibers, graphite fibers, and mixtures thereof.

Preferably, the filler is chosen from fibrous fillers. It is more preferably a reinforcing fiber that is able to withstand the high temperature applications.

The reinforcing agents may be present in the composition (C) in a total amount of greater than 5 wt. %, notably greater than 10 wt. %, greater than 15 wt; %, greater than 20 wt. % by weight, greater than 25 wt. % or greater than 30 wt. %, based on the total weight of the polymer composition (C). The reinforcing agents may be present in the composition (C) in a total amount of less than 65 wt. %, less than 60 wt. %, less than 55 wt. % or less than 50 wt. %, based on the total weight of the polymer composition (C).

The reinforcing filler may for example be present in the composition (C) in an amount ranging between 5 and 60 wt. %, for example between 15 and 50 wt. %, based on the total weight of the polyamide composition (C).

The composition (C) of the present invention may also comprise a toughener. A toughener is generally a low glass transition temperature (T_{g}) polymer, with a T_{g} for example below room temperature, below 0° C. or even below −25° C. As a result of its low T_{g}, the toughener are typically elastomeric at room temperature. Tougheners can be functionalized polymer backbones.

The polymer backbone of the toughener can be selected from elastomeric backbones comprising polyethylenes and copolymers thereof, e.g. ethylene-butene; ethylene-octene; polypropylenes and copolymers thereof; polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core-shell elastomers of methacrylate-butadiene-styrene (MBS) type, or mixture of one or more of the above.

When the toughener is functionalized, the functionalization of the backbone can result from the copolymerization of monomers which include the functionalization or from the grafting of the polymer backbone with a further component.

Specific examples of functionalized tougheners are notably terpolymers of ethylene, acrylic ester and glycidyl methacrylate, copolymers of ethylene and butyl ester acrylate; copolymers of ethylene, butyl ester acrylate and glycidyl methacrylate; ethylene-maleic anhydride copolymers; EPR grafted with maleic anhydride; styrene-maleimide copolymers grafted with maleic anhydride; SEBS copolymers grafted with maleic anhydride; styrene-acrylonitrile copolymers grafted with maleic anhydride; ABS copolymers grafted with maleic anhydride.

The toughener may be present in the composition (C) in a total amount of greater than 1 wt. %, greater than 2 wt. % or greater than 3 wt. %, based on the total weight of the composition (C). The toughener may be present in the composition (C) in a total amount of less than 30 wt. %, less than 20 wt. %, less than 15 wt. % or less than 10 wt. %, based on the total weight of the polymer composition (C).

The composition (C) may also comprise other conventional additives commonly used in the art, including plasticizers, colorants, pigments (e.g. black pigments such as carbon black and nigrosine), antistatic agents, dyes, lubricants (e.g. linear low density polyethylene, calcium or magnesium stearate or sodium montanate), thermal stabilizers, light stabilizers, flame retardants, nucleating agents, antioxidants and polymeric, oligomeric and small molecule crosslinking agents such as modified styrene acrylic polymers and oligomers, bis-phenol A diglycidyl ether and tris(4-hydroxyphenyl) methane triglycidyl ether.

The composition (C) may also comprise one or more other polymers, preferably (co)polyamides different from the (co)polyamide of the present invention. Mention can be made notably of semi-crystalline or amorphous polyamides, such as aliphatic polyamides, semi-aromatic polyamides, and more generally the polyamides obtained by polycondensation between an aromatic or aliphatic saturated diacid and an aliphatic saturated or aromatic primary diamine, a lactam, an amino-acid or a mixture of these different monomers.

### Preparation of the Composition (C)

The invention further pertains to a method of making the composition (C) as above detailed, said method comprising melt-blending the polyamide (A) and the specific components, e.g. a filler, a toughener, a stabilizer, and of any other optional additives.

Any melt-blending method may be used for mixing polymeric ingredients and non-polymeric ingredients in the context of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. If a reinforcing agent presents a long physical shape (for example, a long glass fiber), drawing extrusion molding may be used to prepare a reinforced composition.

### Articles

The present invention also relates to shaped articles comprising the polyamide (A) of the present invention, described above or the composition (C) of the present invention, described above.

According to an embodiment, the article comprising the polyamide (A) of the present invention or the composition (C) of the present invention is processed in a dry state, and has a moisture content of less than 0.5 wt. %, or less than 0.2 wt. %, with respect to the total weight of the article.

The article can notably be a disposable down hole tool that desirably decomposes when exposed to a well bore environment; exemplary embodiment's of disposable downhole tools are notably plugs that are used in a well stimulation/fracturing operation, commonly known as “frac plugs” and which generally provide for means for retaining a ball that acts as a one-way check valve, generally referred as a “fracking ball” (fracturing ball or frac ball), and fracking balls.

The article made of the polyamide (A) or the composition (C) of the present invention can also be used in the medical field, e.g. as a resorbable suture thread or dissolvable implants.

The article can be molded from the polyamide (A) or the composition (C) of the present invention, by any process adapted to thermoplastics, e.g. extrusion, injection molding, blow molding, rotomolding or compression molding.

The article made of the polyamide (A) or the composition (C) of the present invention can also be in the form of a thread or a filament to be used in a process of 3D printing (e.g. Fused Filament Fabrication).

### Use of the Polyamide (A) or the Composition (C), and Articles Therefrom

The polyamide (A) or the composition (C) of the present invention, or any articles therefrom can be used in oil and gas extraction applications, for example to prepare articles presenting a thermal stability at high operating temperature and a sufficient solubility in aqueous media to be dissolved when needed, for example after fracturing.

The polyamide (A) or the composition (C) of the present invention can also be used as a sizing agent, e.g. to treat/coat polymer fibers (e.g. polyamide fibers) or carbon fibers.

The (polyamide (A) or the composition (C) of the present invention can also be used in the medical field, for example to prepare resorbable or dissolvable materials, e.g. in the form of a thread or implantable articles.

The polyamide (A) or the composition (C) of the present invention, or any articles therefrom, may find use as support materials to print 3D parts.

Method of Making a 3D Article with an Additive Manufacturing System Using Polyamide (A), Composition (C) or any Articles Therefrom as Support Material

As said, polyamide (A) or the composition (C) of the present invention, or any articles therefrom can be used as support materials which are required during 3D printing to provide vertical and/or lateral support in the higher operating conditions required for the high-temperature part materials (e.g. PEEK requiring a chamber temperature of exceeding 200° C.). 3D printing support materials present a high melting temperature, exceeding 250° C., so as to confer thermal resistance, so as not to soften under the high temperature operating conditions. Support material also present water absorption behaviour such to enable sufficient swelling, dispersion and deformation upon exposure to aqueous media, or even solubility in said aqueous media, so enabling easy detaching from target 3D printed part.

Another object of the present invention is hence a method for manufacturing a three-dimensional object with an additive manufacturing system, comprising:
providing a support material comprising polyamide (A) or composition (C), as described above;
providing a part material;
printing layers of a sacrificial support structure from the provided support material, and printing layers of the three-dimensional object from the provided part material in coordination with the printing of the layers of the support structure, where at least a portion the printed layers of the support structure support the printed layers of the three-dimensional object; and
removing at least a portion of the sacrificial support structure from the three-dimensional object so as to obtain the three-dimensional object.

The support material generally consists essentially of polymer (A) or composition (C); support material is provided generally in a dry state; to this aim, the support material is generally dried prior to being delivered to and used in the additive manufacturing system.

As such, the support material provided to the additive manufacturing system preferably has a moisture content of less than 0.5% wt, preferably of less than 0.2% wt, with respect to the total weight of the support material. A preliminary drying step may be required to achieve this low moisture content by heating between 60 to 200 C the support material at atmospheric temperature (under air or nitrogen) or under vacuum for the desired amount of time.

The part material provided in the method of the present invention is generally a material requiring a processing temperature of at least 300° C. or beyond. Part materials which are generally associated in the method of the invention to the support material, as above detailed, are notably polysulfones, including polyethersulfones, polyphenylsulfones; polyaryletherketones, including polyetheretherketone, polyetherketoneketone; polyetherimides, polyamideimides, polyphenylenesulfides, polyphenylenes, liquid crystal polymers, polycarbonates, aromatic and semi-aromatic polyamides, including notably metaxylylenediamine adipate (MXD6), and the like.

Generally, the step of printing layers of the three-dimensional object from the part material is hence carried out printing part material in the molten state at a temperature of at least 300° C., preferably at least 350° C.

According to certain preferred embodiments, the method of the invention is a method for manufacturing a three-dimensional object with an extrusion-based additive manufacturing system, otherwise known also as fused filament fabrication technique.

The support material, according to these embodiments, is provided under the form of a filament. The filament may have a cylindrical or substantially cylindrical geometry, or may have a non-cylindrical geometry, such as a ribbon filament geometry; further, filament may have a hollow geometry, or may have a core-shell geometry, with the support material of the present invention being used to form either the core or the shell.

Yet, the support material, according to these embodiment's may be also provided in powder form, e.g. for being fed through an auger-pump print head.

When the method is an extrusion-based additive manufacturing system, the step of printing layers of a sacrificial support structure from the provided support material comprises:
a) feeding the support material to a discharge head member having a throughbore ending with a discharge tip, and a circumferential heater to melt the material in the throughbore;
b) compressing the support material with a piston, for example with the unmelted filament acting as a piston, in said throughbore, while simultaneously melting the support material in the discharge head member, so as to extrude a ribbon of support material from the discharge tip; and
c) ensuring relative movement in x and y directions of the discharge tip and of a receiving platform while discharging support material on said receiving platform to form the cross sectional shape of the sacrificial support structure; and
d) ensuring relative movement in the z direction of the discharge tip and the receiving platform while discharging support material on said receiving platform to form the sacrificial support structure in elevation.

According to these embodiments, the step of printing layers of the three-dimensional object from the provided part material in coordination with the printing of the layers of the sacrificial support structure, advantageously further comprises:
a′) feeding the part material to a discharge head member having a throughbore ending with a discharge tip, and a circumferential heater to melt the material in the throughbore;
b′) compressing the part material with a piston, for example with the unmelted filament acting as a piston, in said throughbore, while simultaneously melting the part material in the discharge head member, so as to extrude a ribbon of part material from the discharge tip; and
c) ensuring relative movement in x and y directions of the discharge tip and the receiving platform bearing the sacrificial support structure, while discharging support material on said receiving platform and said sacrificial support structure to form the cross sectional shape of the three-dimensional object, and
d) ensuring relative movement in the z direction of the discharge tip and the receiving platform while discharging part material on said receiving platform and said sacrificial support structure, to form the three-dimensional object in elevation.

The method of the invention comprises a step of (iv) removing at least a portion of the sacrificial support structure from the assembly so as to obtain the three-dimensional object.

This method generally involves exposing the assembly to an aqueous medium.

When exposing to the said aqueous medium, pure water can be used. Nevertheless, exposure to water solutions acidified through the addition of acid(s), and possibly complemented with polar protic solvents (e.g. ethanol, isopropanol, ethylene glycol); or electrolytes (e.g. sodium chloride, lithium chloride). Generally water is present in the aqueous medium used for this exposure in a concentration of at least 30% wt, preferably at least 50% wt.

As per the acid(s) used in the aqueous medium, acetic acid can be advantageously used, although other inorganic or organic acid can be equally found effective. Concentration of the acid(s) in the aqueous medium is not critical, and even diluted aqueous solutions comprising less than about 10% wt., preferably less than about 8% wt. more preferably less than about 6% wt., e.g. about 5% wt. have been found effective.

This exposure can be realized in any manner.

According to certain embodiment's step (iv) includes contacting/immersing the assembly with/in the aqueous medium. In this case, the aqueous medium temperature for the immersing/contacting is generally about room temperature, i.e. temperatures of 20 to 25° C., although higher temperatures may equally be used, up to about 100° C.

The duration of exposure to the aqueous medium is not particularly limited, and exposure times of at least 1 hour may be effective, and will be adapted by one of ordinary skills in the art depending on the geometry of the sacrificial support structure to be detached and solubilized.

As an outcome of step (iv), the sacrificial support structure is removed from the assembly; the said sacrificial support structure can be advantageously detached from the three-dimensional object and removed in its solid form. Nevertheless, the use of polyamide (A) or composition (C) enables the removal of the sacrificial support structure to be achieved through at least partial solubilisation in water.

Should the disclosure of any patents, patent applications, and publications which are incorporated herein by reference conflict with the description of the present application to the extent that it may render a term unclear, the present description shall take precedence.

### EXAMPLES

### Methods

Thermogravimetric analysis (TGA) was conducted under nitrogen according to the method ASTM E2550.

Differential scanning calorimetry (DSC) analysis was conducted using a heating and cooling rate of 20° C./min according to the method ASTM D3418. Glass transition and melting temperatures were determined from the second heat ramp results.

Gel permeation chromatography (GPC) was performed following an internal method, employing a WatersModular SEC Instrument, a Waters Alliance 2695 Separation Module, a Waters 2487 Dual Absorbance Detector, a Waters 2414 Refractive Index Detector, a Waters 515 pump and Waters Empower Pro Gel Chromatography Software. The instrument was equipped with two PL gel 10 μm MiniMixe B 250×4.6 mm columns and a guard column The samples were dissolved at 5 to 6 g/L in HFIP containing 0.05 M NaFTA; a 15 μl sample was injected. Elution was conducted at 40° C. Results were calibrated against a broad MW internal standard, AMODEL® 1000, M_{w}=27943, Mₙ=9340, M_{w}/Mₙ=2.99.

### Monomers:

1-(2-Aminoethyl) piperazine CAS No. 140-31-8; 1,4-Bis-(3-aminopropyl) piperazine CAS No. 7209-38-3; and 1,4-cyclohexanedicarboxylic acid CAS No. 1076-97-7 were supplied by Aldrich.

N-(6-aminohexyl)-N-methyl-1,6-hexanediamine CAS No. 41318-22-3, DYTEK® T amine was supplied by Invista

### Other Materials

White Distilled Vinegar from Publix, 5 wt % acetic acid

### Comparative Example 1 (AEP,CHDA)

A 25 g reactor was charged with 7.60 g (58.2 mmol) 1-(2-aminoethyl) piperazine (AEP) of formula:

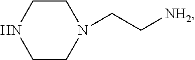

9.73 g (56.5 mmol) cyclohexanedicarboxylic acid (CHDA), 15.4 mg sodium hypophosphite (0.145 mmol), and 7.33 g deionized water. Nitrogen gas was flushed through the system for 5 minutes before heating the reactor to 280° C. and a pressure of 300 psig (20.7 bar). Pressure was maintained at 300 psig for 30 minutes, while the temperature increased to 288° C. Pressure was slowly release from 300 psig to ambient pressure over the course of 50 minutes. The temperature was held at 280° C. for 50 minutes until nitrogen gas was purged through the system and turned off to cool down. The product was removed from the reactor as a light amber, transparent resin. The resin had a Mn of 9.1 kg/mol, a Mw of 15.9 kg/mol (PDI-1.74), and a glass transition at 166° C.; no melting temperature was detected, indicating obtaining a substantially amorphous polyamide.

### Solubility of Comparative Example 1

To a glass vial, 1.08 g resin and 2.08 g household white vinegar were added together and shaken. The resin was fully dissolved over-night at room temperature and produced a homogeneous brown viscous solution.

### Example 2 (mBHT,CHDA)

A 25 g reactor was charged with 9.81 g (42.1 mmol) N-methyl-bis-hexamethylenetriamine (mBHT) of formula:

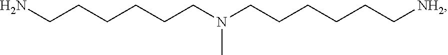 [SMILES: CN(CCCCCCN)CCCCCCN]

7.05 g (40.9 mmol) cyclohexanedicarboxylic acid (CHDA), 20.0 mg sodium hypophosphite (0.145 mmol), and 6.80 g deionized water. Nitrogen gas was flushed through the system for 5 minutes before heating the reactor to 280° C. and a pressure of 300 psig (20.7 bar). Pressure was maintained at 300 psig for 30 minutes, while the temperature increased to 288° C. Pressure was slowly release from 300 psig to ambient pressure over the course of 50 minutes. The temperature was held at 280° C. for 50 minutes until nitrogen gas was purged through the system and turned off to cool down. The product was removed from the reactor as an opaque cream colored plug.

### Solubility of Example 2

To a glass vial, 6.17 g resin and 15.0 g household white vinegar were added together and shaken. The resin was fully dissolved over-night at room temperature and produced a clear homogeneous solution.

### Example 3 (BAPP,CHDA)

A 25 g reactor was charged with 9.29 g (45.9 mmol), 4-bis(3-aminopropyl) piperazine (BAPP) of formula:

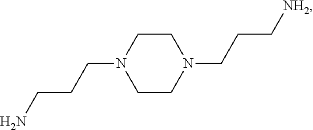 [SMILES: NCCCN1CCN(CCCN)CC1]

7.68 g (44.6 mmol) cyclohexanedicarboxylic acid (CHDA), 12.0 mg phosphorous acid (0.145 mmol), and 7.14 g deionized water. Nitrogen gas was flushed through the system for 5 minutes before heating the reactor to 275° C. and 320 psig. The pressure was maintained at 320 psig for 40 minutes while the reactor temperature increased to 285° C. Pressure was slowly released from the reactor for 45 minutes until ambient pressure was reached. The reactor maintained temperature at 285° C. for 45 minutes until nitrogen was flushed through the system and the reactor was turned off to cool down. The product was removed as a homogeneous opaque light yellow plug.

### Solubility of Example 3

A vial was charged with 0.4 g of Example 3 resin and 6.4 g distilled water. The vial was placed in a Burrell Wrist Action Shaker and allowed to agitate overnight. The resin sample disintegrated into a cloudy dispersion.

A vial was charged with 0.46 g of Example 3 product and 4.74 g of a 6.5 wt % aqueous citric acid solution. The solution was agitated overnight and a cloudy dispersion resulted, including a small solid sediment and a suspension.

TABLE 1

| Monomers | Ex. 1C | Ex. 2 | Ex. 3 |
|---|---|---|---|
| 1,4-cyclohexanedicarboxylic | 50 | 50 | 50 |
| acid (% mol.) | | | |
| 1-(2-Aminoethyl)piperazine | 50 | — | — |
| (% mol.) | | | |
| N-(6-aminohexyl)-N-methyl- | — | 50 | — |
| 1,6-hexanediamine (% mol.) | | | |
| 4-bis(3-aminoproply)piperazine | — | — | 50 |
| (% mol.) | | | |

Solubility in household vinegar of 5 wt % acetic acid

| | | |
|---|---|---|
| YES | YES | YES |

Thermal and Molecular Weight Properties

| | | | |
|---|---|---|---|
| Tg (° C.) | 166 | 84 | 115 |
| Tm (° C.) | — | 260 | 279 |
| Mₙ | 9100 | 30500 | 19200 |
| M_{w} | 15900 | 99300 | 40100 |

The examples show facile dissolution and dispersion in a mild acidic solution-household vinegar of 5 wt % acetic acid, in addition to showing good molecular weight and thermal properties. The high Tm2 of examples 2 and 3 demonstrate that the peculiar structures of amine (N_{N}¹) and amine (N_{N}²) is critical for combining high melting behaviour and easy dissolution in mild acid aqueous media. Indeed, polyamide of Ex. 1C (of comparison), based on a combination of acid (CHDA) with a diamine which, despite comprising a tertiary amine group, is not providing for two-(CH₂)ₙ—NH₂ moieties, is leading to an amorphous structure, which is not suitable for withstanding high temperature conditions.

Data of Ex. 2 and 3 suggest that materials of the invention could be useful for Fused Filament Printing at high build chamber temperatures, i.e. temperatures ≥200° C. These compositions could allow the use of dissolvable support material at high build chamber temperatures that maximize the mechanical strength of printed parts.

1. A (co)polyamide comprising at least 85 mole % of recurring units (R_{PA}) of formula (I): 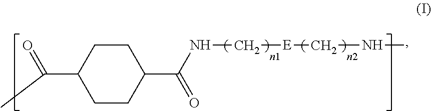
with respect to the total moles of recurring units of said (co)polyamide [polyamide (A)], wherein:
each of E, equal or different at each occurrence, is a group of any of formula (I_{N}¹) or (I_{N}²): 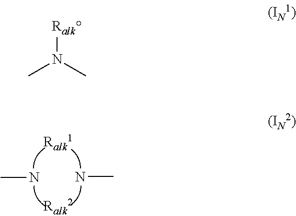
where Rₐₗₖ^{∘} is a mono-valent C₁-C₁₂ hydrocarbon group, comprising one or more than one heteroatom; each of Rₐₗₖ¹ and Rₐₗₖ², equal to or different from each other, are a bond or a divalent C₁-C₁₂ hydrocarbon groups, comprising one or more than one heteroatom, with the provision that Rₐₗₖ¹ and Rₐₗₖ² are not simultaneously a bond, together forming a heterocyclic mono- or poly-nuclear group with the nitrogen atoms to which they are connected; and
n1 and n2, equal to or different from each other and at each occurrence, are integers, in particular from 1 to 12.

2. The polyamide (A) of claim 1, wherein recurring units (R_{PA}) of formula (I) are selected from the group consisting of:
units (R_{PA}¹) of formula: 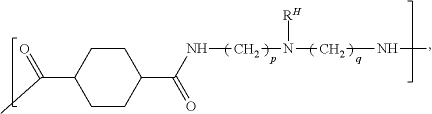
wherein p and q, equal to or different from each other, are independently an integer of 3 to 9; R^{H} is a mono-valent C₁-C₆ alkyl group; and
units (R_{PA}²) of formula: 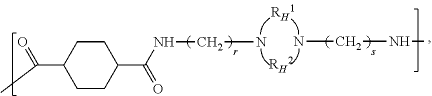
wherein r and s, equal to or different from each other, are independently an integer of 1 to 3; each of R_{H}¹ and R_{H}², equal to or different from each other are a bond of a divalent C₁-C₁₂ alkylene group and wherein R_{H}¹ and R_{H}² are together forming an azacycloalkane with the nitrogen atoms to which they are connected.

3. The polyamide (A) of claim 2, wherein units (R_{PA}¹) are those wherein each of p and q are equal to 6, that is to say those of formula: 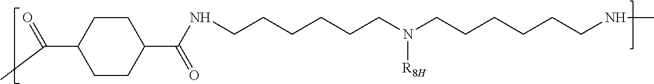
whereas R_{BH} is a C₁-C₃ alkyl group; and/or
wherein units (R_{PA}²) are selected from the group consisting of:
units of formula: 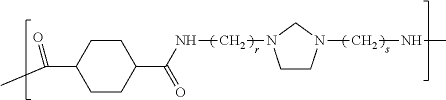
wherein r and s, equal to or different from each other, are independently an integer of 1 to 3;
units of formula: 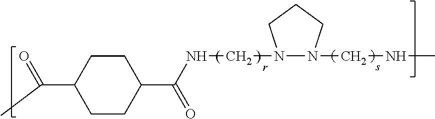
wherein r and s, equal to or different from each other, are independently an integer of 1 to 3;
units of formula: 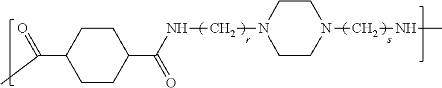
wherein r and s, equal to or different from each other, are independently an integer of 1 to 3;
units of formula: 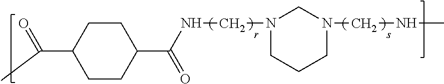
wherein r and s, equal to or different from each other, are independently an integer of 1 to 3;
units of formula: 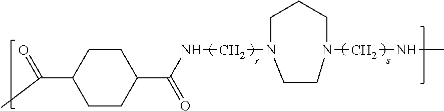
wherein r and s, equal to or different from each other, are independently an integer of 1 to 3;
units of formulae: 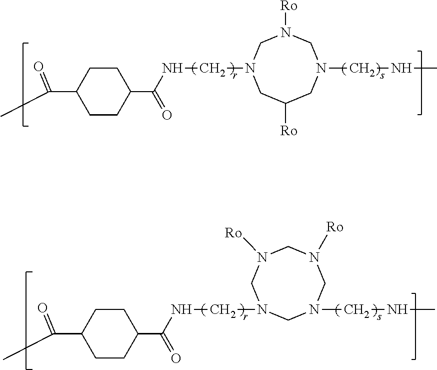
wherein Ro is H or a C₁-C₃ alkyl group, and r and s, equal to or different from each other, are independently an integer of 1 to 3;
units of formula: 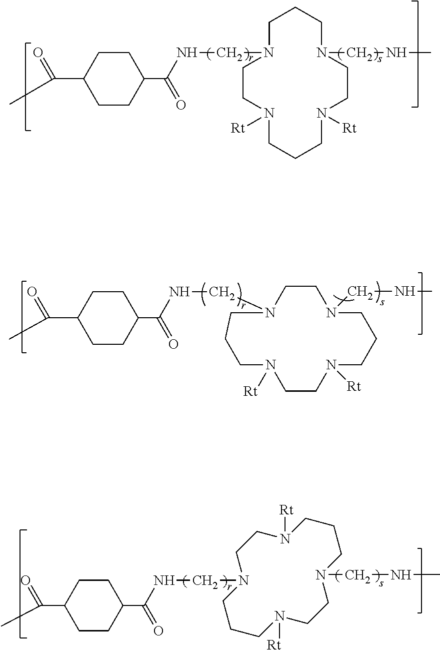
wherein Rt is H or a C₁-C₃ alkyl group, and r and s, equal to or different from each other, are independently an integer of 1 to 3.

4. The polyamide (A) according to claim 3, wherein units (R_{PA}²) are of formula: 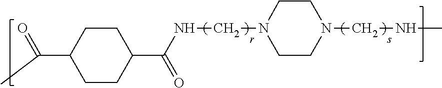
wherein r and s, equal to or different from each other, are independently an integer of 1 to 3.

5. The polyamide (A) according to claim 1, said polyamide (A) comprising at most 15 mol. %, with respect to the total moles of recurring units of the polyamide (A), of recurring units different from those of formula (I) above, which comply with any of the formulae: 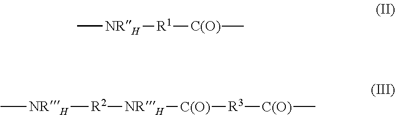
wherein R″_{H} and R′″_{H}, equal to or different from each other and at each occurrence, are H or a hydrocarbon group; and R¹, R², R³, equal to or different from each other, are divalent hydrocarbon groups, and are aliphatic, alicyclic, cycloaliphatic, aromatic or combinations thereof, wherein R¹, R², R³ optionally contain one or more than one heteroatom selected from the group consisting of O, N, S, P, and wherein said recurring units (II) and (III) different from units of formula (I) of the polyamide (A) are the condensation product of at least one mixture selected from:
mixtures (M1) comprising at least a diacid [acid (DA)] (or derivative thereof) and at least a diamine [amine (NN)] (or derivatives thereof), wherein (i) acid (DA) is not an acid (CHDA) and/or (ii) amine (NN) is not an amine (N_{N}¹) nor an amine (N_{N}²);
mixtures (M2) comprising at least a lactam [lactam (L)];
mixtures (M3) comprising at least an aminocarboxylic acid [aminoacid (AN)]; and
combinations thereof.

6. The polyamide (A) according to claim 1, wherein polyamide (A) is a homopolyamide or a quasi-homopolyamide essentially consisting of recurring units (R_{PA}) of formula (I).

7. The polyamide (A) according to claim 1, having a number average molecular weight MN ranging from 1 000 g/mol to 50 000 g/mol, the number average molecular weight being determined by gel permeation chromatography (GPC) following ASTM D5296 instructions, using monodisperse polystyrene standards.

8. The polyamide (A) according to claim 1, said polyamide being semi-crystalline and having an amorphous phase and a crystalline phase, leading to a detectable melting point, as determined by Differential Scanning calorimetry according to ASTM D3418.

9. The polyamide (A) according to claim 1, having a crystallinity such that its heat of fusion is at least 15 J/g, when determined by Differential Scanning calorimetry according to ASTM D3418.

10. The polyamide (A) according to claim 1, having a melting point of at least about 250° C., as determined according to ASTM D3418.

11. A method of making the polyamide (A) according to claim 1, said method comprising thermal polycondensation of a monomer mixture of one or more than one 1,4-cyclohexanedicarboxylic acid [acid (CHDA)] (or derivative thereof) and a diamine component consisting of one or more than one diamine (or derivatives thereof) of any of formulae: 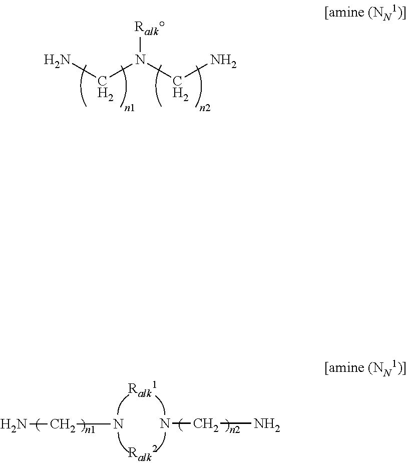
where Rₐₗₖ^{∘} is a mono-valent C₁-C₁₂ hydrocarbon group, comprising one or more than one heteroatom; each of Rₐₗₖ¹ and Rₐₗₖ², equal to or different from each other, is a bond or a divalent C₁-C₁₂ hydrocarbon group, comprising one or more than one heteroatom, with the provision that Rₐₗₖ¹ and Rₐₗₖ² are not simultaneously a bond, and wherein Rₐₗₖ¹ and Rₐₗₖ² are together forming a heterocyclic mono- or poly-nuclear group with the nitrogen atoms to which they are connected; and
n1 and n2, equal to or different from each other and at each occurrence, are integers, in particular from 1 to 12,
and optionally additionally comprising at least one mixture selected from:
mixtures (M1) comprising at least a diacid [acid (DA)] (or derivative thereof) and at least a diamine [amine (NN)] (or derivatives thereof), wherein (i) acid (DA) is not an acid (CHDA) and/or (ii) amine (NN) is not an amine (N_{N}¹) nor an amine (N_{N}²);
mixtures (M2) comprising at least a lactam [lactam (L)];
mixtures (M3) comprising at least an aminocarboxylic acid [aminoacid (AN)]; and
combinations thereof, as described above.

12. The method of claim 11, wherein in the monomer mixture, the molar ratio n_{diacid}/n_{diamine} ranges from 0.8 to 1.2.

13. A composition (C) comprising at least one polyamide (A) according to claim 1, and further comprising at least one component selected from the group consisting of reinforcing agents, tougheners, plasticizers, colorants, pigments, antistatic agents, dyes, lubricants, thermal stabilizers, light stabilizers, flame retardants, nucleating agents, crosslinking agents and antioxidants.

14. A composition (C) comprising at least one polyamide (A) according to claim 1, and further comprising at least one reinforcing filler selected from glass fibers and carbon fibers.

15. A shaped article made from the polyamide (A) according to claim 1.

16. A shaped article made from the composition (C) of claim 13.
